(19) United States
(12) Patent Application Publication
(10) Pub. No.: US 2015/0130347 A1
(43) Pub. Date: May 14, 2015

(54) PROTECTING METHOD FOR FLAT PANEL DISPLAY AND PROTECTING FILM ATTACHED FLAT PANEL DISPLAY

(71) Applicants: Yong-Oon HWANG, Gyeonggi-do (KR); DongHo KANG, Gyeonggi-do (KR)

(72) Inventors: Yong-Oon HWANG, Gyeonggi-do (KR); DongHo KANG, Gyeonggi-do (KR)

(21) Appl. No.: 14/602,706

(22) Filed: Jan. 22, 2015

Related U.S. Application Data
(62) Division of application No. 13/845,954, filed on Mar. 18, 2013.
Application No. 13/845,954 is a continuation-in-part of application No. 12/758,016, filed on Apr. 11, 2010, now abandoned.

(30) Foreign Application Priority Data
Jan. 15, 2010 (KR) 10-2010-0003783

(51) Int. Cl. H05B 33/04; H05B 33/22

(52) U.S. Cl. CPC H05B 33/04; H05B 33/22
USPC 313/512

(57) ABSTRACT

A method for protecting a flat display panel in which a resin film with adhesive agent is attached to a color filter glass substrate or an encapsulation glass of the flat display panel and the resin film attached fiat display panel is cut into a plurality of cells to protect the flat display panel during a following manufacturing processes is provided.

### CROSS-REFERENCE TO RELATED APPLICATIONS

This application claims the priority benefit of Korean Patent Application No. 10-2010-0003783, filed on Jan, 15, 2010 and continuation of Ser. No. 12/758016 filed on Apr. 11, 2010 to USPTO. The entirety of the aforementioned applications are incorporated by reference herein.

### BACKGROUND

I. Field of the Invention

The following description relates generally to a flat display panel, and more particularly to a protecting method for the flat display panel during a manufacturing of the flat display panel.

II. Description of the Related Art

A flat display panel such as LCD, PDP, and OLED is manufactured in general by forming a TFT circuit or organic layer deposition pixel on a bare glass and sealing the pixel with color filter glass substrate or encapsulation glass.

The aforementioned manufacturing of the flat display panel consists of many detail processes such as slimming process for the glass substrate, cutting process to obtain a desired cell size, a wiring process for circuit, formation, IC attachment process, and several collateral processes.

During the manufacturing of the flat display panel, scratches may occur on the color filter glass substrate or the encapsulation glass of the flat display panel (hereinafter, the color filter glass substrate or the encapsulation glass of the flat display panel is referred to as the flat display panel glass). The scratches may then cause a defect in the flat display panel glass as thickness of the flat display panel glass decreases. Therefore, there exists a need for a method to protect the flat display panel glass during the manufacturing process.

In U.S. Pat. No. 7,202,923B2, to reduce a period time for producing a single liquid crystal panel, the TFT glass is sealed with CF(color filter) glass and then stuck with polarizing plate. Next, the polarizing plate is cut away by blade as a strip along a cutting line and the panel is cut by a wheel cutter into a plurality of cells. However, the peeling of the polarizing plate makes entire process delay and a probability of scratches on the glass.

### SUMMARY

The following presents a simplified summary of one or more embodiments in order to provide a basic understanding of such embodiments. This summary is not an extensive overview of all contemplated embodiments.

A preferred embodiment of the present invention provides a protecting method to prevent a thin flat display panel glass from scratching during a manufacturing process of the flat display panel.

According to an aspect of the present invention, a method that protecting a flat display panel from scratching during a manufacturing process, wherein a pre-formed resin film sheet with adhesive agent on the back side is attached to the outside of the flat display panel glass, is provided.

Yet another aspect of the present invention provides a method for cutting the flat display panel glass into a plurality of cells, on which a pre-formed resin film sheet with adhesive agent is attached to protect the flat display panel from scratching during a following manufacturing processes. The cutting process can be embodied the state that the pre-formed resin film sheet is attached on the flat display panel, whereby a cutting tool will cut the flat display panel glasses together with the pre-formed resin film sheet. The following manufacturing processes can be proceeded with the pre-formed resin film sheet attached on the fiat display panel to protect without peeling.

Another aspect of the present invention provides a method for attaching a pre-formed resin film sheet with adhesive agent on the back side onto the outside of a flat display panel glass to protect from scratching during a manufacturing process wherein the pre-formed resin film sheet is constituted with a high molecule resin characterized by a thickness of 3 to 30 μm.

A further aspect of the present invention provides a method for attaching a high molecule pre-formed resin film sheet with adhesive agent to a flat display panel glass to protect from scratching during a manufacturing process wherein the high molecule pre-formed resin film sheet is selected from one of PET (polyethylene terephthalate) or PE (polyethylene) or PP (polypropylene) or PO (polyolefine).

Still another aspect of present invention provides a protecting film attached flat display panel manufactured by the processes of attaching a high molecule pre-formed resin film sheet with thickness of 3 to 30 μm to the flat display panel glass and cutting the flat display panel glass into a plurality of cells, on which the pre-formed resin film sheet with adhesive agent is attached.

### BRIEF DESCRIPTION OF THE DRAWINGS

FIG. 1 is a sectional view of a pre-formed resin film sheet for protecting flat panel display accordance with a preferred embodiment of the present invention.

FIG. 2 is a sectional view of an apparatus for attaching a pre-formed resin film sheet for protecting flat panel display accordance with a preferred embodiment of the present invention; and

FIG. 3 is a sectional view of protecting film attached flat display panel accordance with a preferred embodiment of the present invention.

### DETAILED DESCRIPTION

Hereinafter, preferred embodiments of the present invention will be described in detail with reference to the drawings, wherein like reference numerals are used to refer to like elements throughout.

In the following description, for purpose of explanation, numerous specific details are set forth in order to provide a thorough understanding of the aspects and features of the present invention and methods for achieving the aspects and features. However, the present invention is not limited to the embodiments disclosed hereinafter. It should be apparent that the teaching herein can be embodied in a wide variety of forms and that any specific matters defined in the description, such as the detailed construction and elements, is merely representative. Based on teachings herein one skilled in the art should appreciate that an aspect disclosed herein can be implemented independently of any other aspects.

The main concept of the present invention is to provide a method to protect a flat display panel during a manufacturing process. A way of attaching a protecting film (“protecting film” means “pre-formed resin film sheet”) onto the outside of a glass substrate or an encapsulation glass of the flat display panel (hereinafter, the glass substrate or an encapsulation glass of the flat display panel is referred to as the flat display panel glass) as an attempt to protect the at display panel, however, makes it impossible to cut the fiat display panel glass to obtain a desired cell size of the flat display panel using a conventional diamond wheel cutting method if the protecting film thickness is over 30 μm. Therefore the conventional diamond wheel cutting process of the protecting film attached flat display panel glass only leads to a partial cutting of the protecting film layer, and thus the flat display panel glass is not cut completely into the desired cell size of the flat display panel. Yet a way of screen printing of a paste using a mask pattern to a residual part of the flat display panel glass excluding the part for cut to obtain a desired cell size, as an another attempt to protect the flat display panel glass, produces several undesirable problems in manufacturing process such as a need of separate mask patterns for different desired cell size, overhead in collateral drying process following the screen printing of a paste, and a deterioration of manufacturing efficiency and productivity due to occurrence of bed smell and increase in pollution material discharge. Following preferred embodiments of the present invention will described a method to protect a flat display panel during a manufacturing process wherein the described method can overcome the disadvantages in the aforementioned attempted methods for protecting the flat display panel.

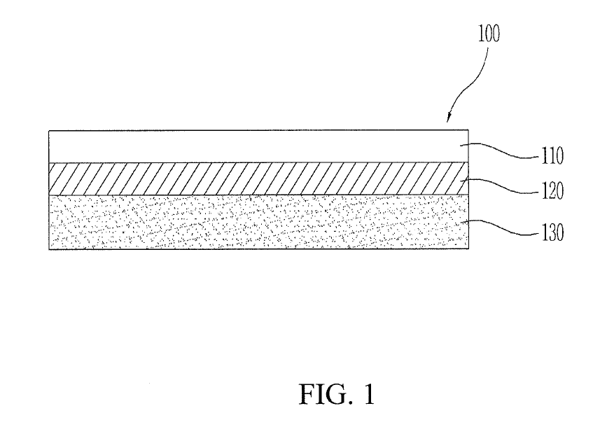

FIG. 1 illustrates a schematic configuration of a pre-formed resin film sheet 100 for protecting flat panel display accordance with a preferred embodiment of the present invention. Referring to FIG. 1, the pre-formed resin film sheet 100 comprises resin layer 110, adhesive agent 120, and hetero film sheet 130. The resin layer 110 may be constituted with a high molecule resin. The high molecule resin layer 110 can be selected from one of PET (polyethylene terephthalate) or PE (polyethylene) or PP (polypropylene) or PO (polyolefine).

A thickness of the resin layer 110 can be preferably 3 to 30 μm (more preferably 5 to 15 μm) for providing an enough thickness to protect a flat display panel glass. If the thickness of the resin layer 110 is more than 30 μm, a conventional glass scriber such as the diamond heel type glass scriber cannot be used for cutting the pre-formed resin film sheet 100 attached flat display panel glass.

Therefore, in the present invention, a conventional glass scriber can be used due to the said thickness of the resin layer 110.

A thickness of the adhesive agent 120 can be preferably 10 μm. Since the hetero film 130 sticks to the adhesive agent 120 it order to protect the adhesive composition and is detached from the adhesive agent 120 when the pre-formed resin film sheet 100 is attached to the outside of the flat display panel glass, a thickness of the hetero film sheet 130 need not be limited. A preferable thickness 25 μm of the hetero film sheet 130, however, is suggested as a preferred embodiment of the present invention.

The protecting film is of course transparent and not a polarizer. It can function only to transmit light and protect the glass surface.

In more detail, the pre-formed resin film sheet 100 is attached to the outside surface of the glass substrate or an encapsulation glass of the flat display panel.

The glass substrate has been sealed with encapsulation glass and they are faced on each other. The pre-formed resin film sheet 100 is attached on the opposite surface to the faced surface.

The aforementioned configuration of a pre-formed resin film sheet 100 for protecting flat panel display accordance with a preferred embodiment of the present invention provides several advantages for manufacturing of the flat display panel. A preferable thickness 3 to 30 μm of resin layer 110 can protect the flat display panel glass during the manufacturing of the flat display panel and make possible using the conventional diamond wheel type glass scriber often used for cutting only the flat display panel glass without attaching a protecting film.

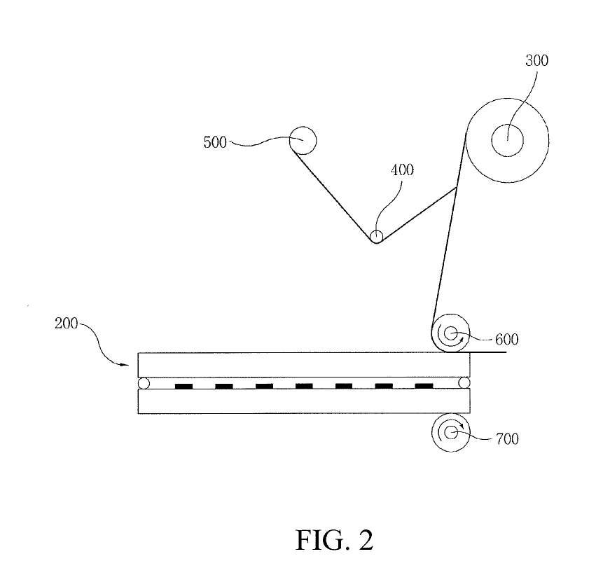

FIG. 2 illustrates a sectional view of an apparatus for attaching the pre-formed resin film sheet 100 of FIG. 1 for protecting flat panel display 200 accordance with a preferred embodiment of the present invention.

The apparatus automatically attaches the pre-formed resin film sheet 100 of FIG. 1 after a slimming process and thus can protect the flat panel display 200 through the follow-up processes such as cutting process, modularization process, and inspection process.

Referring to FIG. 2, a flat display panel 200 (after a slimming process) is placed under the first roller 300 whereon the pre-formed resin film sheet 100 of FIG. 1 is wound around. Before placing the flat display panel 200 under the first roller 300, the hetero film sheet 130 of FIG. 1 is detached manually from the pre-formed resin film sheet 100 of FIG. 1 and is fixed on the second roller 500 by an adhesive tape in order to wind around the second roller 500. Furthermore, a pressurizing rod 400 is installed between the first roller 300 and the second roller 500 such that the hetero film 130 can be tightly expanded in order to wind around the second roller 500 well.

As the hetero film sheet 130 of FIG. 1 is detached from the pre-formed resin film sheet 100 of FIG. 1, the adhesive agent 120 of FIG. 1 can directly contacted on the flat display panel 200 placed under the first roller 300.

The flat display panel 200 and the pre-formed resin film sheet 130 of FIG. 1 contacted thereon are placed on the first rubber roller 600 for pressurizing and attaching the pre-formed resin film sheet 100 of FIG. 1 to the flat display panel 200.

The outside of the surface of a bare glass substrate on which TFT circuits or organic layer is deposited can also be protected by attaching the pre-formed resin film sheet 100 of FIG. 1. For this case, the second rubber roller 700 can be installed in order to attach the pre-formed resin film sheet 100 of FIG. 1 to the rare surface of the flat display panel 200.

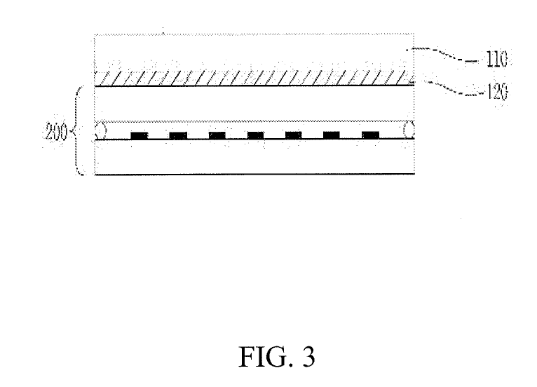

FIG. 3 illustrates a sectional perspective view of cutting the protecting film attached flat display panel accordance with a preferred embodiment of the present invention. The cutting process can be embodied in the state that the pre-formed resin film sheet is attached on the flat display panel as shown FIG. 3, whereby a cutting tool will cut the flat display panel glasses together with the pre-formed resin film sheet. The following manufacturing processes can be proceeded with the pre-formed resin film sheet attached on the flat display panel to protect without peeling.

The protecting film attached flat display panel can not only protect the flat panel display 200 through the follow-up processes but also reinforce the strength of the flat display panel 200. The strength of the flat display panel 200 can be improved more than 1.5 times through the protecting film attaching process accordance with a preferred embodiment of the present invention.

What is claimed is:

1. A flat display panel comprising:
glass substrate or an encapsulation glass;
a protecting film attached to entire outside of the surface of the glass substrate or the encapsulation glass to protect from scratch, wherein the outside surface means the opposite surface to the surface faced with the glass substrate and the encapsulation glass,
the protecting film is a pre-formed resin film sheet with an adhesive agent on the back side, transparent film and not polarizer.

2. A flat display panel of claim 1,
Wherein the pre-formed resin film sheet has a high molecule resin layer; and
a thickness of the high molecule resin layer is 3 to 30 μm.
